(19) United States
(12) Patent Application Publication
(10) Pub. No.: US 2002/0112336 A1
(43) Pub. Date: Aug. 22, 2002

(54) Sheared-off fastener removal tool

(76) Inventor: Jake Merrick, Hinton, OK (US)

Correspondence Address: James E. Bradley, BRACEWELL & PATTERSON, LLP, P.O. Box 61389, Houston, TX, 77208-1389, US

(21) Appl. No.: 10/039,075

(22) Filed: Dec. 31, 2001

Related U.S. Application Data
(60) Provisional application No. 60/259,019, filed on Dec. 29, 2000.

(51) Int. Cl. B23P 19/02

(52) U.S. Cl. 29/426.4

(57) ABSTRACT

A tool has a member that inserts into a bore formed in a threaded workpiece to grip and rotate the workpiece. The tool has a head having a polygonal socket for insertion of a drive member. A shank extends from the head for insertion into the bore of the workpiece. The shank has cam surfaces on its sidewall. Jaw inserts engage the cam surfaces, such that rotation of the head causes the jaw inserts to slide along the cam surfaces to grip the bore of the workpiece. A retaining band extends around the jaw inserts to retain the jaw inserts on the shank and maintain a desired spacing between the jaw inserts.

This application claims the provisional application priority date of Dec. 29, 2000, Ser. No. 60/259,019.

### TECHNICAL FIELD

This invention relates in general to devices for unscrewing fasteners and in particular to a tool which will remove threaded members that have been sheared off near or inside the hole in which they are threaded.

### Background Art

There are numerous applications in which externally threaded members such as bolts have been sheared off near or inside the internally threaded hole in which they are threaded. In these instances, very little if any of the threaded member extends beyond the opening of the socket and cannot be easily gripped for removal by tools such as the one described in U.S. Pat. No. 5,351,382. The difficulty of removing such a threaded member is particularly enhanced when it has rusted due to exposure to extreme conditions of temperature and weather. Also, the threaded member may have been initially installed under considerable torque. As a result, breaking out the remnant of this type of threaded member is often a difficult task.

### SUMMARY OF THE INVENTION

The tool of this invention has a portion that inserts into a bore formed in the sheared off fastener. The tool has a head having a polygonal socket on a proximal end for insertion of a drive member. A shank extends from a distal end of the head for insertion into the bore of the fastener. A plurality of cam surfaces are formed on the shank. A plurality of jaw inserts engage the cam surfaces. Rotation of the head by the drive member causes the jaw inserts to slide along the cam surfaces to grip the bore of the fastener. Continued rotation will cause the fastener to unscrew.

### BRIEF DESCRIPTION OF THE DRAWINGS

FIG. 1 is an isometric view of a removal tool constructed in accordance with the invention.

FIG. 2 is a sectional end view of the removal tool of FIG. 1 taken along the line 2-2 of FIG. 1 and shown inside a sheared-off threaded member in a hole.

FIG. 3 is an elevational view of the retaining band for the tool of FIG. 1, shown laid out flat.

### BEST MODE FOR CARRYING OUT THE INVENTION

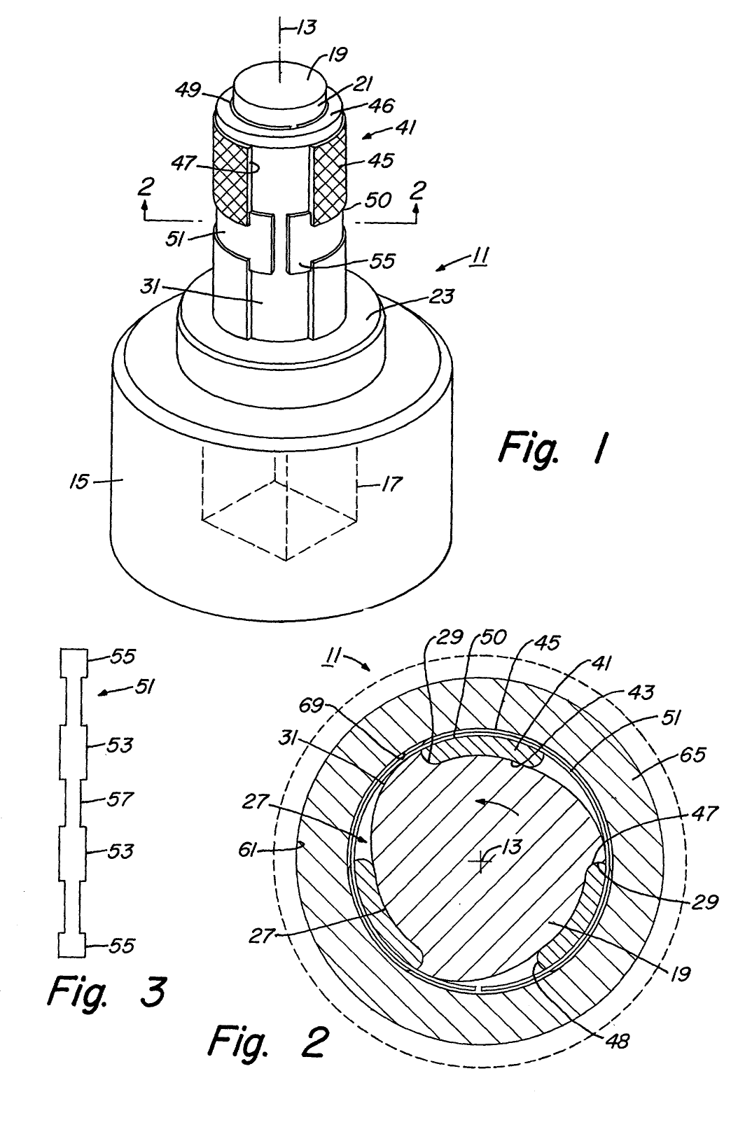

Referring to FIG. 1, a tool 11 having a longitudinal axis 13 is shown. Tool 11 has a head 15 with a concentric internal head socket 17 on one end. Head socket 17 is designed to receive the drive shaft of an impact wrench or other tool (not shown) and may have a number of configurations. In the preferred embodiment, head socket 17 has a square opening that closely receives a square-shaped drive shaft.

A solid shank 19 extends coaxially from the other end of head 15. Shank 19 is a separate member from head 15 and has a lower cylindrical end (not shown) press fitted with an interference fit into a hole provided in the upper or distal end of head 15. Shank 19 has a cylindrical sidewall 21 on its upper or distal end that is concentric with axis 13. An upward-facing shoulder 23 is formed on head 15 near the interface between head 15 and shank 19. Shoulder 23 is larger in diameter than shank 19 and is in a plane perpendicular to axis 13.

As shown in FIG. 2, shank 19 has three identical outer cam surfaces 27 that are 120 degrees out of phase. Each cam surface 27 has a concave shoulder 29 at the end of cam surface 27 that has a maximum radial depth in shank 19. Each cam surface 27 extends helically outward from shoulder 29 to a partially cylindrical portion 31 of shank 19. Shoulder 29 smoothly transitions into cylindrical portion 31 and vice-versa. Cylindrical portion 31 is formed on a single radius from axis 13, while cam surface 27 is formed on a continuously increasing radius from axis 13. One of the cylindrical portions 31 separates each cam surface 27 from another cam surface 27. Shoulder 29 and cylindrical portion 31 give shank 19 an undulating and variable outer diameter.

Drive member 11 also has three arcuate jaw inserts 41. Each insert 41 has a smooth inner surface 43 and a textured or knurled outer radial surface 45. Inner surface 43 is contoured to match the shape of each of the cam surfaces 27. In the preferred embodiment, outer surface 45 has a plurality of short teeth which extend away from it. Outer surface 45 is a segment of a cylinder with a single radius about axis 13. Jaw insert 41 also has a pair of side edges or ends 47, 48 that define a thickness of jaw insert 41. Side end 47 is closer to cam surface shoulder 29 and is thicker than side end 48, which is closer to cylindrical surface 31.

A circumferential recess 50 is formed in each outer surface 45 about halfway between the distal and proximal ends of each insert 41. Recess 50 divides the knurled portion of outer surface 45 into upper and lower portions. The circumferential dimension of jaw insert 41, as measured between side ends 47, 48, is approximately one half of the distance from one shoulder 29 to another shoulder 29.

Jaw inserts 41 are retained on drive member 11 at the distal end by a washer 46 and a split ring 49, which engages a groove in sidewall 21. Split ring 49 may be of a variety of types, but is preferably an E-clip of conventional design.

The final component of the invention is a retaining ring band 51. Split ring band 51 is an annular member that retains jaw inserts 41 on drive member 11. As shown in FIG. 3, split ring band 51 has two intermediate bosses 53 located intermediate two end bosses 55. Each boss 53, 55 is rectangular section that has a greater width than the remaining central portions 57. The central portions 57 fit closely in recesses 50 on insert outer surfaces 45. Bosses 53, which are too wide to fit within recesses 50, locate between and contact two adjacent side ends 47, 48 of two of the inserts 41. End bosses 55 are rectangular tabs on the ends that also are too wide to fit within recesses 50. End bosses 55 are about one-half the length of an intermediate boss 53 and approximately abut each other. Intermediate bosses 53 and end bosses 55 maintain a desired circumferential spacing between inserts 41.

In operation, tool 11 is assembled by placing the inner surface 43 of a jaw insert 41 on each of the cam surfaces 27. Inner surfaces 43 are contoured to fit closely and smoothly on cam surfaces 27 for sliding motion thereon. Prior to use of tool 11, jaw inserts 41 should be positioned near shoulders 29 so that shank 19 has a minimum outer diameter profile with jaw inserts 41 in place. Retaining band 51 is placed within recesses 50 around jaw inserts 41 and drive member 11 so that jaw inserts 41 are held snugly in place against cam surfaces 27. Washer 46 and retaining ring 49 are secured to cylindrical sidewall 21 of shank 19.

After the tool 11 is assembled, it is used to remove threaded members which have been sheared off near or inside the socket in which they are threaded. Tool 11 is available in various diameters and lengths so that it maybe used to remove sheared off members of various sizes. For example, a threaded hole 61 contains a sheared-off bolt 65 having external threads, which are indicated by the dotted lines in FIG. 2. A concentric bore 69 is drilled in bolt 65 to prepare it for removal with tool 11. Bore 69 should have an inner diameter that is slightly larger than the outer diameter of tool 11 at inserts 41 while they are abutting shoulders 29. Bore 69 should have sufficient depth to allow shoulder 23 of drive member 11 to very nearly abut the outer edge of bolt 65.

Drive member 11 is attached to the drive shaft of an impact wrench (not shown). The drive shaft is closely received by and engages head socket 17 in head 15. As the drive shaft and drive member 11 are rotated counterclockwise (FIG. 2), the smooth interfaces between insert inner surfaces 43 and cam surfaces 27 cause jaw inserts 41 to slip toward cylindrical portions 31 away from shoulders 29. Retaining band 51 also slips in unison with jaw inserts 41 and maintains their spacing relative to each other. Jaw inserts 41 are forced radially outward by cam surface 27 since the diameter of shank 19 increases in that direction. The split in retaining band 51 allows its diameter to also increase with the increase in relative diameter of jaw inserts 41. The effective diameter of jaw inserts 41 increases until jaw inserts 41 engage the side walls of bore 69.

As shank 19 rotates, the teeth on the outer surfaces 45 of jaw inserts 41 are forced into engagement with and slightly embed into the sides of bore 69 of bolt 65. When shank 19 and jaw inserts 41 mechanically lock with bolt 65, the rotation of the drive member and shank 19 relative to jaw inserts 41 will cease and bolt 65 will be forced to rotate with tool 11 if the drive member has sufficient torque. The external threads of bolt 65 will then disengage the internal threads of hole 61 until bolt 65 is removed from hole 61. After use, shank 19 may be removed from bore 69 by temporarily restraining bolt 65 and reversing the rotational direction of the impact wrench. This motion will disengage the teeth on outer surfaces 45 of jaw inserts 41 from bore 69, and allow jaw inserts 41 to slide toward shoulders 29. With the outer diameter of tool 11 reduced at jaw inserts 41, shank 19 may be removed from bore 69.

The invention has significant advantages. The tool will readily grip and rotate bolts that have sheared off. The expanding diameter caused by the jaw inserts sliding on the cam surfaces provide excellent gripping abilities. The retaining band maintains desired spacing between the jaw inserts. Press fitting the shank into a hole in the head avoids stress areas that would otherwise result from machining the shank and head from an integral piece.

While the invention has been shown in only one of its forms, it should be apparent to those skilled in the art that it is so limited but is susceptible to various changes without departing from the scope of the invention.

I claim:

1. A tool for insertion into a bore of a workpiece to grip and rotate the workpiece, comprising:
a head having a polygonal socket for insertion of a drive member;
a shank extending from the head for insertion into the bore of the workpiece;
a plurality of cam surfaces formed on the shank; and
a plurality of jaw inserts engaging the cam surfaces, such that rotation of the head causes the jaw inserts to slide along the cam surfaces to grip the bore of the workpiece.

2. The tool according to claim 1, further comprising:
a circumferentially extending recess formed in an outer surface of each of the jaw inserts; and
a retaining ring extending around the jaw inserts and located in the recess to retain the jaw inserts on the shank.

3. The tool according to claim 1, further comprising:
a circumferentially extending recess formed in an outer surface of each of the jaw inserts; and
a retaining band extending around the jaw inserts and located in the recesses to retain the jaw inserts on the shank, the retaining band having bosses formed at each end and intermediate the ends, the bosses being wider than the recesses and engaging side ends of the jaw inserts to maintain a desired spacing between the jaw inserts.

4. The tool according to claim 1, further comprising:
a circumferentially extending recess formed in an outer surface of each of the jaw inserts substantially midway between proximal and distal ends of the jaw inserts; and
a retaining band extending around the jaw inserts and located in the recesses to retain the jaw inserts on the shank, the retaining band having bosses formed at each end and intermediate the ends, the bosses being wider than the recesses to maintain a desired spacing between the jaw inserts.

5. The tool according to claim 1, wherein the shank has a proximal end that is press-fitted into a hole provided in the head.

6. The tool according to claim 1, further comprising:
a removable distal retaining ring located on a distal end of the shank in engagement with distal ends of the jaw inserts.

7. The tool according to claim 1, further comprising:
A circumferentially extending recess formed in an outer surface of each of the jaw inserts substantially midway between proximal and distal ends of the jaw inserts;
a central retaining ring extending around the jaw inserts and located in the recesses to retain the jaw inserts on the shank; and
a removable distal retaining ring located on a distal end of the shank in engagement with distal ends of the jaw inserts.

8. The tool according to claim 1, wherein the jaw inserts have a greater thickness at one side end than another side end.

9. A tool for insertion into a bore of a workpiece to grip and rotate the workpiece, comprising:
a head having a polygonal socket for insertion of a drive member;
a shank extending from the head for insertion into the bore of the workpiece, the shank having a cylindrical end that is press-fitted into a hole in the head;
a plurality of cam surfaces formed on the shank;
a plurality of jaw inserts engaging the cam surfaces, such that rotation of the head causes the jaw inserts to slide along the cam surfaces to grip the bore of the workpiece;
a circumferentially extending recess formed in an outer surface of each of the jaw inserts substantially midway between proximal and distal ends of the jaw inserts; and
a retaining band extending around the jaw inserts and located in the recesses to retain the jaw inserts on the shank, the retaining band having bosses formed at each end and intermediate the ends, the bosses being wider than the recesses and engaging side ends of the jaw inserts to maintain a desired spacing between the jaw inserts, the retaining band sliding in unison with the jaw inserts.

10. The tool according to claim 9, further comprising:
a removable retaining ring located on a distal end of the shank in engagement with the distal ends of the jaw inserts.

11. The tool according to claim 9, wherein the jaw inserts have a greater thickness at one side end than another side end.

12. The tool according to claim 9, wherein each of the cam surfaces joins a partially cylindrical portion on the shank.

13. A method of removing a threaded workpiece from a threaded hole, comprising:
providing a tool with a head having a polygonal socket, a shank extending from the head, the shank having cam surfaces formed thereon, and a plurality of jaw inserts engaging the cam surfaces;
drilling a hole in the workpiece;
inserting the shank and jaw inserts into the hole;
inserting a drive member into the socket and rotating the head, causing the jaw inserts to slide along the cam surfaces, expand in effective diameter, and grip the workpiece, and continuing to rotate the head to cause the workpiece to unscrew from the threaded hole.
